(19) United States
(12) Patent Application Publication
(10) Pub. No.: US 2009/0255228 A1
(43) Pub. Date: Oct. 15, 2009

(54) Lawn stripping assembly

(75) Inventor: Steven A. Sprinkmann, Germantown, WI (US)

Correspondence Address: WELLS ST. JOHN P.S., 601 W. FIRST AVENUE, SUITE 1300, SPOKANE, WA, 99201, US

(73) Assignee: S & B Lawn Systems, Inc.

(21) Appl. No.: 12/082,590

(22) Filed: Apr. 11, 2008

(51) Int. Cl. A01B 39/08; A01D 75/00

(52) U.S. Cl. 56/16.7; 172/349

(57) ABSTRACT

A grooming device for use on a walk behind mower which has an operator's handle. The lawn grooming device includes an adjustable tow bar mounted on an operators handle of the walk behind lawn mower; a hitch member mounted on the adjustable tow bar; and a weighted earth engaging roller assembly releasably coupled to the hitch member, and oriented in trailing relation relative to the walk behind lawn mower, and wherein the weighted roller assembly is pivotally moveable in both a horizontal and vertical plane relative to the tow bar.

### TECHNICAL FIELD

The invention pertains to lawn grooming devices, and more specifically to a lawn grooming device which is coupled to, and trails behind a walk behind lawn mower of conventional design.

### BACKGROUND OF THE INVENTION

Lawn grooming devices that aesthetically alter the appearance of mowed grass are popular in many applications. For example, stripers are utilized for grooming sports fields, golf greens, ornamental gardens, etc. However most stripers are fabricated and then incorporated with large riding mowers and/or are made for a specific model or style of mower. Even those devices that are commercially available for walk behind mowers are product specific and tend to be an expensive customization. Furthermore, alternative lawn mower attachments that are popular, such as rear mounted grass-catching bags, have heretofore had an inhibitory influence on the development of any pull-behind type grooming device since the bag or alternative attachment could interfere with the function of the grooming device and vice versa.

A lawn grooming device for utilization with walk behind type grass mowers which avoids the shortcomings in the earlier devices employed heretofore is the subject matter of the present invention.

### SUMMARY OF THE INVENTION

A first aspect the present invention relates to a lawn grooming device for use on a walk behind lawn mower having a rearwardly extending operator's control handle. The lawn grooming device includes an adjustable tow bar mounted on the lawn mower operator's handle. A hitch member is mounted on the adjustable tow bar, and an earth engaging roller assembly is releasably coupled to the hitch member and oriented in trailing relation relative to the walk behind lawn mower. The roller assembly is pivotally moveable in both a horizontal and vertical plane relative to the tow bar.

Another aspect the present invention relates to a lawn grooming device which includes a releasably adjustable tow bar depending downwardly relative to an operator's handle, and which is mounted on a rear end of a walk behind lawn mower. The releasably adjustable tow bar is adjustable as to length, width and angular orientation relative to the lawn mower operator's handle. A hitch member is mounted on the adjustable tow bar.

Still another aspect of the present invention relates to a lawn grooming device which includes a frame having a leading edge, and a trailing edge, and wherein the leading edge is releasably engaged by the hitch member, and wherein the frame further defines a transversably oriented cavity between the leading and trailing edges. The frame is movable in both horizontal and vertical planes relative to the walk behind mower. An earth engaging roller is rotatably mounted in the cavity which is defined by the frame. The roller further defines an internal cavity. A flowable substance is received within the internal cavity of the earth engaging roller, and has the effect of increasing the mass or weight of the earth engaging roller to a degree which allows it to effectively bend blades of grass to produce an aesthetically appealing appearance on a grass surface over which the earth engaging roller travels.

Yet another aspect of the present invention relates to a lawn grooming device for use on a walk behind lawn mower having a rearwardly extending operator's handle. The lawn grooming device has an attachment assembly which defines a channel which is dimensioned to conformally receive and mate with a portion of the operator's handle.

These and other aspects of the invention will be discussed in greater detail hereinafter.

### BRIEF DESCRIPTION OF THE DRAWINGS

Preferred embodiments of the invention are described below with reference to the following accompanying drawings.

FIG. 1 is an environmental, side elevation view of a lawn grooming device in accordance with one aspect of the invention, and which is shown mounted on a walk-behind lawn mower of conventional design.

FIG. 2 is a cross-sectional view taken from a position along line 2-2 as seen in FIG. 6.

FIG. 3 is a fragmentary, perspective view of the lawn grooming device.

FIG. 4 is a partially exploded view of the lawn grooming device depicted in FIG. 1.

FIG. 5 is a top plan view of the lawn grooming device as depicted in FIG. 1.

FIG. 6 is a bottom plan view of the lawn grooming device as depicted in FIG. 1.

FIG. 7 is a front elevation view of the lawn grooming device as depicted in FIG. 1.

FIG. 8 is a rear elevation view of the lawn grooming device as depicted in FIG. 1.

FIG. 9 is a first, side elevation view of the lawn grooming device as depicted in FIG. 1.

FIG. 10 is an opposing, side elevation view of the lawn grooming device as depicted in FIG. 9.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

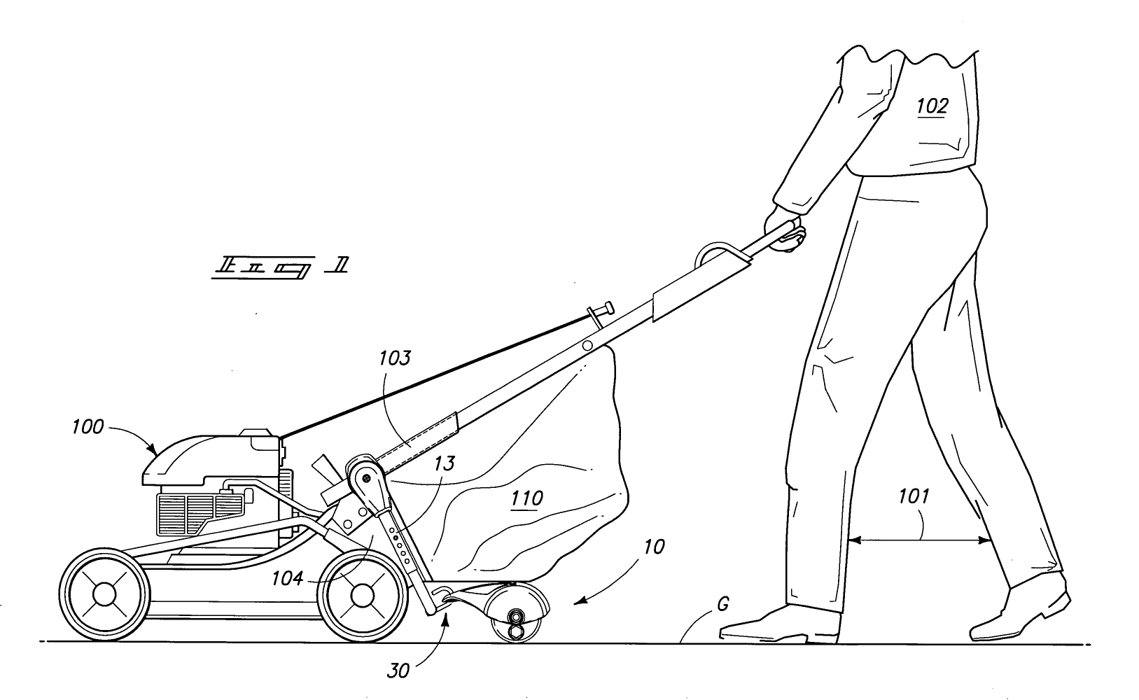

Referring now to FIG. 1, the present invention encompasses lawn grooming devices 10 which are utilized with walk behind type lawn mowers 100 of conventional design. The invention 10 is referred to hereinafter, in some instances, as a lawn striper due to the overall effect of the device 10 bending blades of grass to produce an aesthetically appealing appearance on a grass surface over which the device travels. Lawn striping has heretofore been utilized in a number of applications including, for example, golf greens, sports fields, ornamental gardens, etc. However, striping utilizing smaller walk behind lawn mowers has been limited due to a number of factors such as those discussed in the background section of this application.

The lawn grooming device 10, as described hereinafter, is conveniently adjustable both in height and width, and can adapt to virtually any walk behind style of mower 100. Moreover, the present invention is angularly adjustable such that the distance the device 10 is located behind the mower 100 can be adjusted so as to not meaningfully interfere with the stride 101 of an operator 102 and/or a rear mounted grass catching bag 110 or other lawn mowing attachments.

Embodiments of the invention are described generally with reference to FIGS. 1-10. Referring initially to FIG. 1, this view depicts a lawn grooming device 10 in accordance with the present invention. The lawn grooming device 10 as depicted can be readily attached to a walk behind lawn mower 100 of conventional design and which includes a rearwardly extending operator's control handle 103.

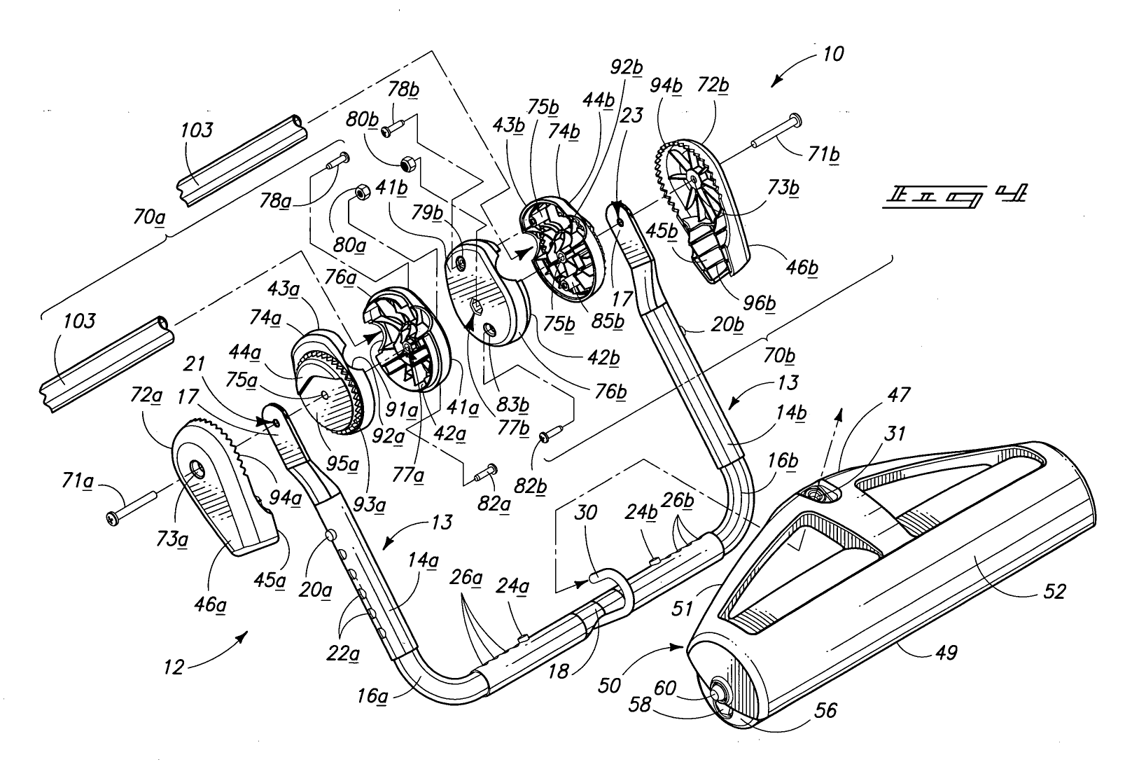

Referring now to FIG. 3, the lawn grooming device 10 as depicted includes an adjustable tow bar 12 which is releasably adjustable and depends downwardly relative to an operator's handle 103 which is mounted on a rear end 104 of a walk behind lawn mower 100. The tow bar 12 is adjustable as to length L, width W, and angular orientation A, relative to the operator's handle 103. The tow bar 12 includes first and second generally vertically oriented support members or side members which are mounted on the operator's handle 103 and depend downwardly therefrom. The generally vertically oriented support members 13 have a first component portion 14a, and 14b and a second component portion 16a, and 16b, respectively. As best appreciated by a study of FIG. 3, the components 16a and 16b are formed into substantially right angularly shaped elbows which have a distal end (not shown), which is received in telescoping relation relative to the first and second component portions 14a and 14b, respectively. The second component portions 16a and 16b each mount on one of their distal ends a biased or depressible button or detent 20a and 20b, respectively. The first component portion 14a and 14b each have a series of spaced holes 22a and 22b (holes 22b are not visible in the view depicted in FIG. 3).

As seen in FIG. 3, the vertical length of the tow bar (L) can be selectively adjusted by slideably and selectively locating the respective second component portions 16a and 16b, by means of the depressible or biased buttons or detents 20a and 20b in one of the plurality of receiving holes in the second component portions 14a and 14b, respectively. The center-to-center distances between the plurality of holes 24a and 24b is not limited to any particular value. In one embodiment, the center-to-center distance between adjacent holes can be about 0.75 inches. Accordingly, the vertical length (L) of the tow bar 12 can be adjusted in predetermined increments of about 0.75 inches so as to accommodate mower handles 103 which are located at various distances above the grass surface (G) as seen in FIG. 1.

The tow bar 12 further includes a substantially horizontally oriented connector member 18 which extends, at least in part, between the substantially vertically oriented support members 14a and 14b, respectively. The connector member 18 is configured to telescopingly receive one of the distal ends of each of the second component portions 16a and 16b, respectively. The second component portions 16a and 16b each have a depressible or biased button or detent 24a and 24b, respectively mounted on the distal end thereof. Connector member 18 further has a plurality of receiving holes 26a and 26b which are configured to matingly receive and cooperate with the biased buttons or detents 24a and 24b, respectively.

The horizontal width (W) of the tow bar 12 can be adjusted by slideably relocating the depressible or biased buttons or detents 24a and 24b from one receiving hole 26a or 26b to another receiving hole within the two series of receiving holes provided by or formed the substantially horizontally oriented connector member 18. The center-to-center distance between the holes 26a and 26b is not limited to a particular value. In one embodiment of the invention, the center-to-center distances between the respective holes can be about 0.5 inches. Accordingly, the horizontal width (W) of the tow bar can be adjusted in predetermined increments of about 0.5 inches so as to accommodate mowers 100 of various widths.

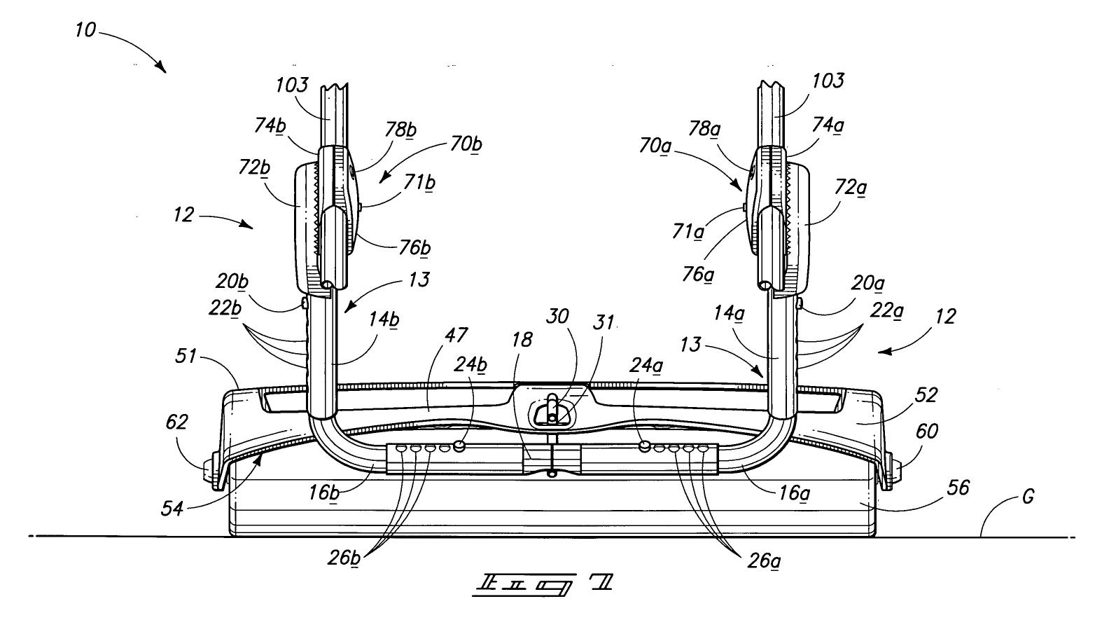

A hitch member 30, which takes the form of a hook, is mounted on the substantially horizontally oriented connector member 18, and is positioned approximately midway along the length of the connector member. The hitch member 30 is configured to releasably engage an earth engaging roller assembly 50. The roller assembly 50 includes a frame 51 having a leading edge 47, and a trailing edge 49. The leading edge 47 is releasably engaged by the hitch member 30 as seen in FIG. 3. The frame 51 defines a transversely disposed cavity 54 (FIG. 6) which is disposed between the leading and trailing edges. The frame is moveable in both horizontal and vertical planes relative to the walk behind lawn mower 100 so that it may substantially conform to or otherwise follow the changes in the topography of the grass (G). This is an important feature of the present invention 10 inasmuch as previous lawn striping devices made integral with lawn mower devices often could not closely follow the topography of the ground especially during those occasions where the topography changed radically.

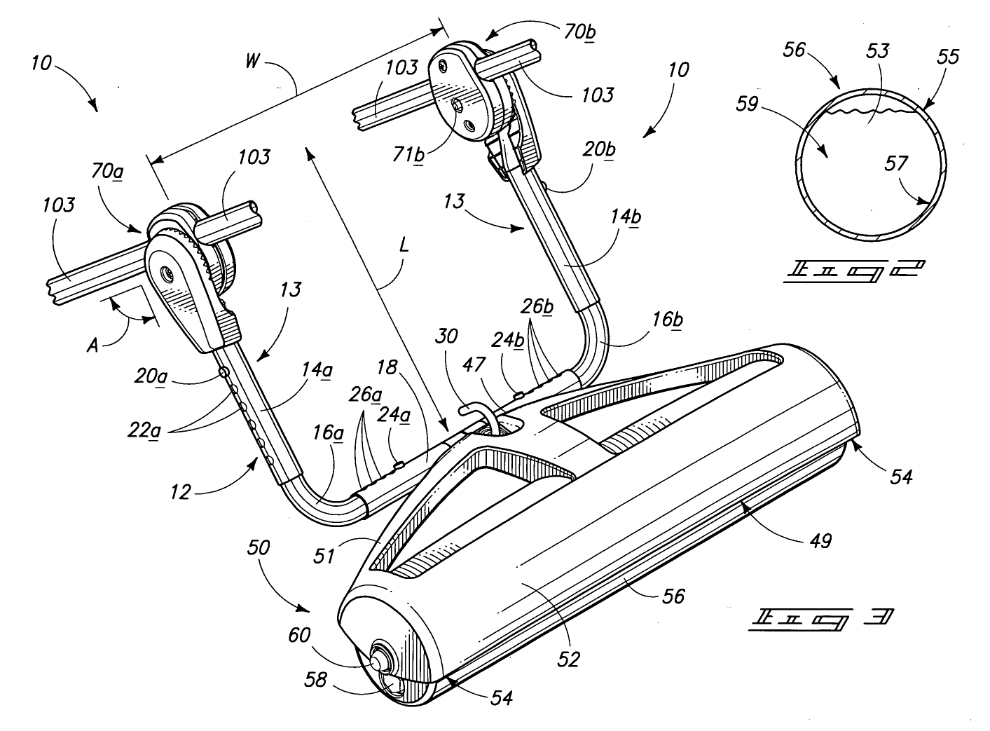

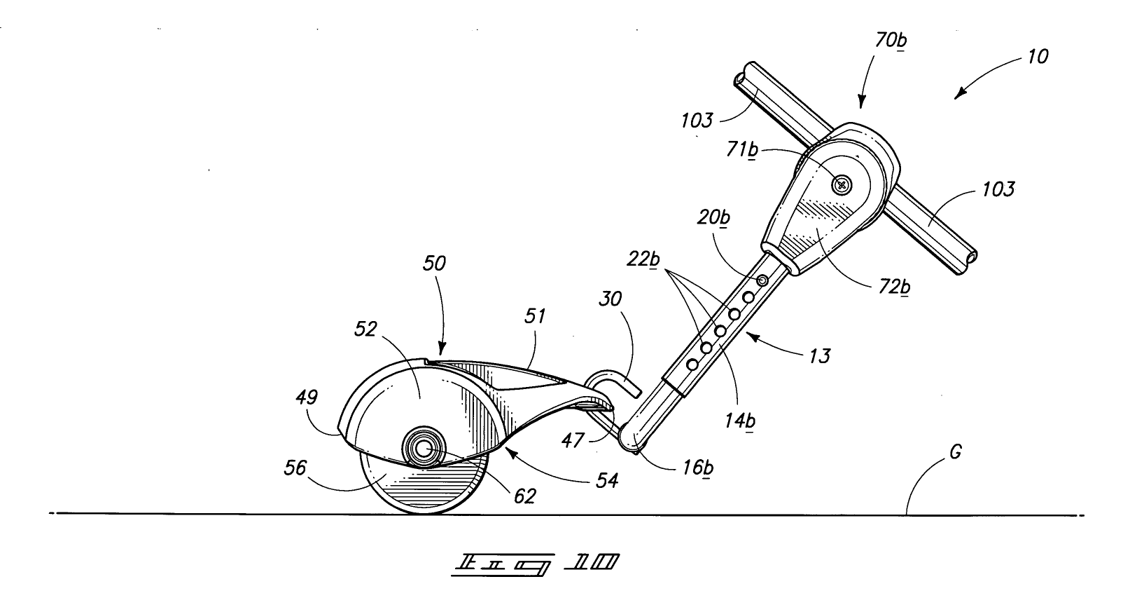

An earth engaging roller 56 is rotatably mounted in the cavity 54 which is defined by the frame 51. Referring to FIG. 2, the roller 56 has an outwardly facing surface 55, and an inwardly facing surface 57 which defines an internal cavity 59. Referring now to FIGS. 3 and 9, the earth engaging roller 56 further defines an aperture 58 which allows access to the internal cavity 59 of the roller. A flowable substance 53 can be delivered into the internal cavity of the earth engaging roller through aperture 58 which will increase the mass of the earth engaging roller to a degree which will permit the earth engaging roller to effectively bend blades of grass over which the earth engaging roller is moved across the surface of the earth. Such a flowable substance 53 can be a liquid such as water for example, a granular solid such as, for example, sand and/or gravel; lead shot; metal pellets; or other forms of metal ballast or combinations thereof, or can be a flowable mixture or slurry that subsequently becomes a solid such as, for example, cement. When filled with the flowable substance, the earth engaging roller 56 can weigh from about 17 pounds to about 34 pounds. The weighted roller assembly, when releasably mounted on the tow bar 12, is pivotally movable in both horizontal and a vertical planes relative to the tow bar, as earlier discussed, to achieve the benefits of the present invention 100.

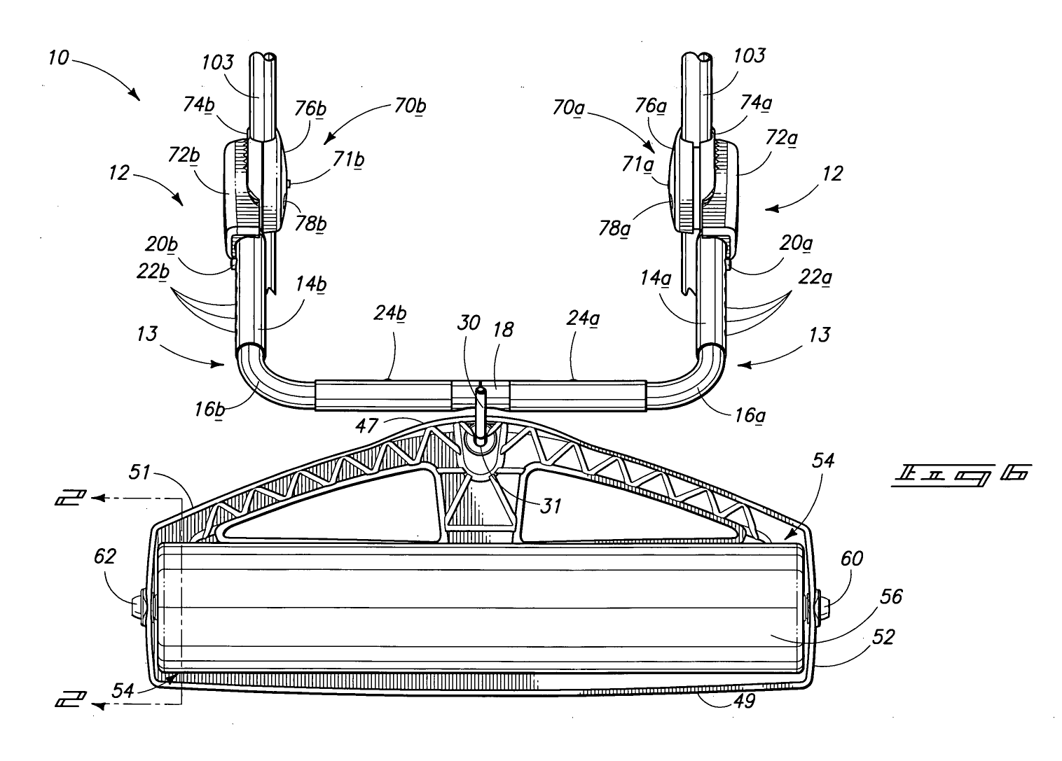

The earth engaging roller 56 is rotatably mounted within frame 51 of roller assembly 50 by axle members 60 and 62, respectively (FIG. 5). Further, the roller assembly 50 defines a fender 52 which is made integral with frame 51, and which is further disposed in spaced, partially covering relation relative to the earth engaging roller 56. This fender inhibits the grass catching bag 110 from contacting the earth engaging roller, and further prohibits an operator's foot 102 from striking same. In the arrangement as depicted in the drawings, the tow bar 12 restrainingly cooperates with the forward, leading edge 47 of the frame 51 so as to impede the over-rotation of the roller assembly 50 about the hitch member 30. This of course, prevents jack knifing which would inhibit the usefulness of the invention when the lawn mower 100 is pulled backwards.

The weighted roller assembly 50 has a length and width dimension which does not substantially interfere with an operator's 102 walking stride 101 as the operator controls the operation of the walk behind lawn mower 100. The width dimension is typically less than the width dimension of the walk behind mower 100. Further, the length dimension is selected so as to allow the frame 51 to be operably deployed in trailing relation relative to the walk behind mower 100, and substantially outside the normal walking stride of an average operator 102. Exemplary dimensions for a typical frame 51 is that it has a length dimension (as measured from the leading edge 47 to the trailing edge 49) of from greater than about 12 inches to less than about 17 inches; and a width dimension (as measured between the axle members 60 and 62) of from greater than about 16 inches, to less than about 21 inches.

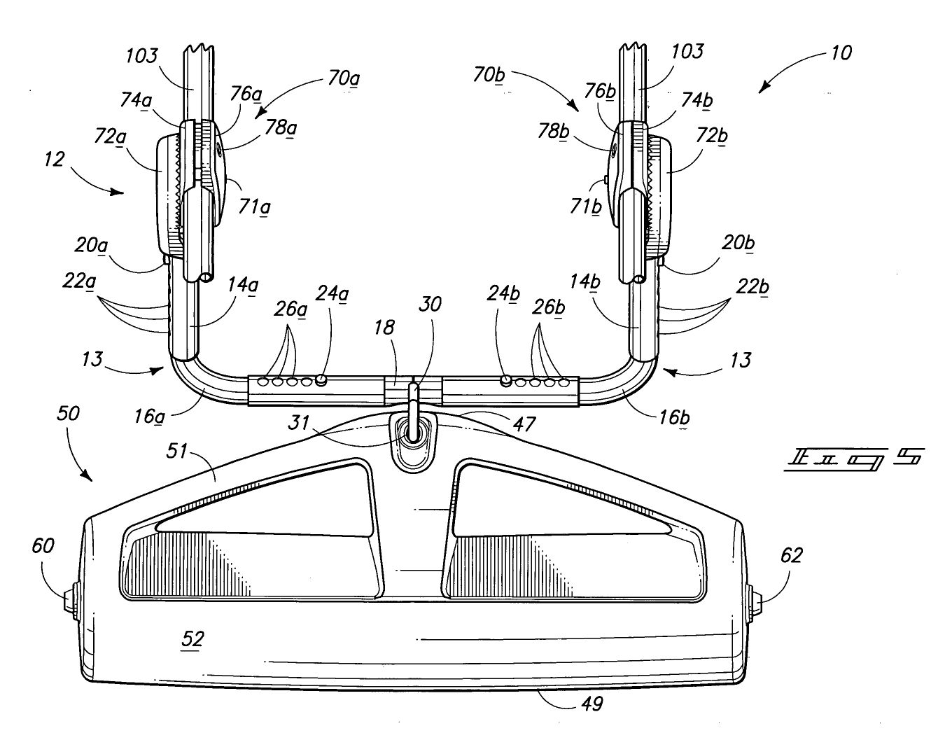

As shown in FIGS. 3 and 4, the lawn grooming device 10 has a pair of attachment assemblies 70a and 70b which fixedly, rigidly attaches the tow bar 12 in a predetermined angularly depending relationship relative to the operator's handle 103. The respective attachment assemblies 70a and 70b allow for selective predetermined angular adjustment of the tow bar 12 relative to the operator's handle 103. Further, the substantially vertically oriented support members 13 have a total range of angular adjustment A, (FIG. 3) of less than about 140 degrees, and are individually angularly adjustable in angular increments of about 10 degrees. Attachment assemblies 70a and 70b are shown in greater detail in FIG. 4.

As shown in the exploded view of FIG. 4, the respective attachment assemblies 70a and 70b are mirror images of one another. Accordingly, the description of the attachment assembly which will follow will be made with reference to only one assembly (assembly 70a). Similar structures will be indicated with a similar number followed by the letter “b”. A first portion 76a of the attachment assembly 70a has a main body defined by an outside facing surface 41a, and an inside facing surface 42a. The inside facing surface 42a defines a channel 91a which is dimensioned to conformably receive and mate, at least in part, with a portion of the operator's handle 103. Further, a second portion 74a of the attachment assembly 70a has a main body defined by an outside facing surface 44a, and an opposite inside facing surface 43a. The inside facing surface defines, at least in part, a channel 92a which is dimensioned to conformably receive and mate with, at least in part, a portion of the operator's handle 103. The second portion 74a matingly fits together with the first portion 76a. The first and second portions are fastened together by, for example, fasteners 78a and 82a so as to securely capture the operator's handle 103 therebetween. The outside facing surface 44a of second portion 74a further defines a plurality of spaced orientation teeth 93a, and a recessed region 95a for receiving a distal end 17 of a depending substantially vertically oriented support member 13.

A third portion 72a of the attachment assembly has a main body defined by an outside facing surface 46a, and an inside facing surface 45a. The inside facing surface defines a channel (not visible in FIG. 4, see 96b) which is dimensioned to conformably receive and mate with, at least in part, a portion of the distal end 17 of the depending substantially vertically oriented support members 13, and secure the distal end 17 therebetween the second and third portions 74a and 72a, respectively. Third portion 72a defines a plurality of spaced orientation teeth 94a which matingly cooperate with the plurality of spaced orientation teeth 93a which are made integral with the second portion 74a so as to permit the third portion 72a to orient the depending substantially vertically oriented support member 13 in a plurality of predetermined angular orientations relative to the operator's handle 103 and in spaced relation relative to the grass surface G.

A pin or other fastener 71a is received through an opening 73a which is formed in the third portion 72a, and further through an opening 21 which is made in the distal end 17 of the substantially vertically oriented support member 13. The pin or fastener 71a further extends through an opening 75a formed in second portion 74a, and then through an opening 77a formed in first portion 76a. Fastener 71a is secured, for example, by a nut 80a. The pin 71a additionally supports and holds together, at least in part, the three portions of the attachment assembly 76a; 74a; and 72a, along with the substantially vertically oriented support member 13.

The ability to readily angularly adjust and otherwise position the lawn grooming device 10 in an appropriate location for the specific type of mower 100 allows the weighted roller assembly 50 to be appropriately positioned so as to avoid substantial interference with an operator's 102 walking stride 101 as the operator walks behind the lawn mower 100. Additionally, the angular adjustment feature of the invention can position the weighted roller assembly 50 such that the weighted roller assembly 50 protects the roller 56 from interference by mower attachments such as, for example, a grass catcher bag 110. The weighted roller assembly 50 can thereby be positioned such that the tow bar 12 does not interfere with the operation of the grass catching bag (see FIG. 1).

Referring now to FIG. 5, this view shows a top view of the present invention 10. As should be apparent from this view, the spaced orientation teeth 93a and 94a (FIG. 4) of the attachment assemblies 70a and 70b are matingly engaged. Additionally, as seen in this view, an opening 31 is formed in the leading edge 47, or the frame 51, and the hitch member 30 engages the frame 51 of the roller assembly 50 by extending through this hole or aperture. Referring next to FIG. 6, such depicts a bottom view of lawn grooming device 10. The frame 51 is typically fabricated from a molded thermoplastic material.

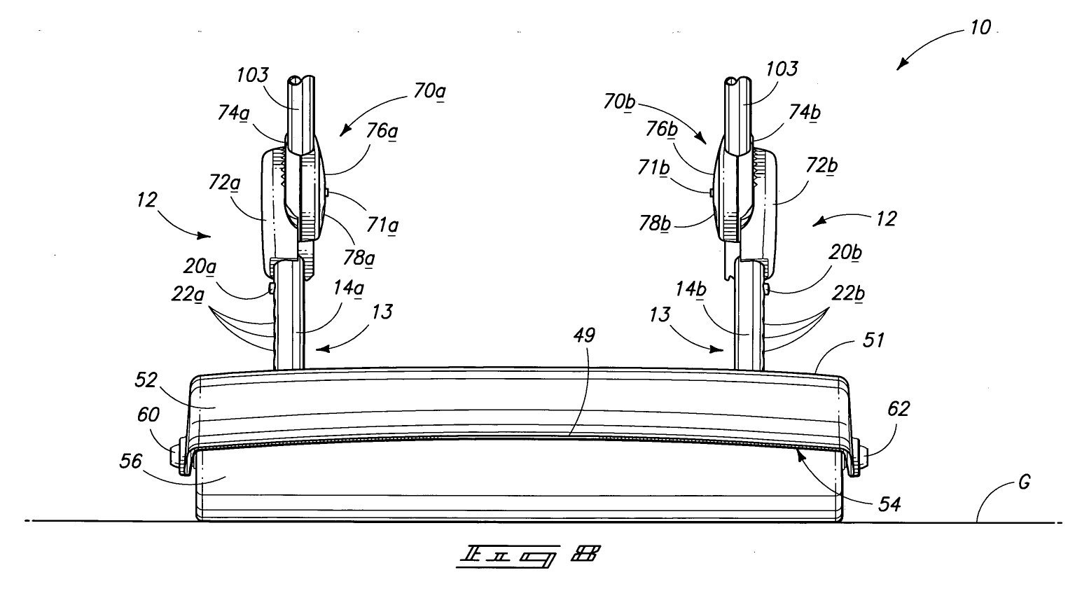

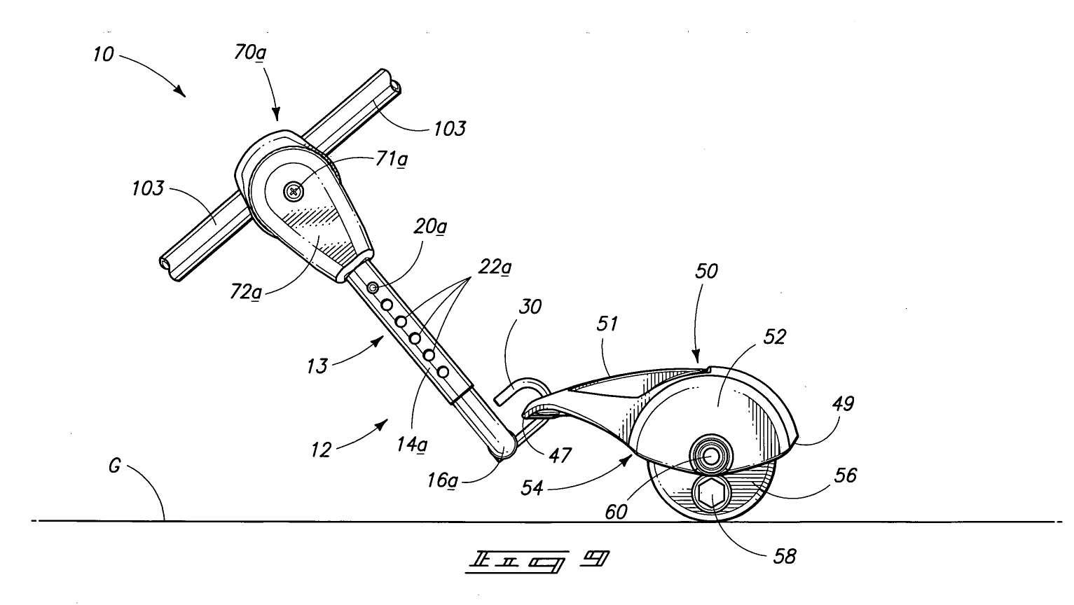

Referring next to FIG. 7, such shows a front elevation view of the lawn grooming device 10. In this view the leading edge 47 of frame 51 is evident. One can also understand how moving or drawing a mower 100 in the reverse direction causes the forward leading edge 47 of the frame 51 to engage the tow bar 12 so as to impede the over-rotation of the lawn grooming device and substantially inhibits jackknifing. A rear elevation view of the invention 10 is shown in FIG. 8. From this view, the trailing edge 49 of frame 51 is apparent. Additionally, it will be seen that the fender 52 is disposed in spaced relationship relative to ground or grass G.

A first side elevation view of the lawn striping assembly 10 is shown in FIG. 9. Visible in this view is the aperture 58 for filling the roller 56 to provide weight for the weighted roller assembly 50. The aperture is occluded by a removable plug. Another aspect of the invention which is apparent from this depiction is the spaced relationship of the tow bar 12 relative to the ground G. The opposing side view of the lawn striping assembly 10 is depicted in FIG. 10.

Referring now to FIG. 1, such shows a conventional type of walk behind lawn mower 100 having a rearwardly extending operator's control handle 103. Also depicted is a rear mounted grass catching bag 110. Typically, the grass catching bag will be releasably mounted on the walk behind lawn mower and extend rearwardly thereof. The grass catching bag is positioned between the operator's handle and the surface of the earth G. FIG. 1 also depicts a lawn grooming device 10 in accordance with the invention mounted to the operator's handle of the lawn mower. As illustrated, the rear mounted grass catching bag rests, at least in part, on the fender 52 of the roller assembly 50, and out of contact with the earth engaging roller 56. The tow bar 12 of the lawn grooming device 10 of the present invention can be adjusted as to its horizontal and vertical dimensions so as to not interfere with the operation of the grass catching bag 110. Further, an angular adjustment of the tow bar 12 can be made so as to not interfere with the stride 101 of the operator 102. Furthermore, the position of the roller assembly 50 can be adjusted so as to best support a grass catching bag 110 or alternative mower attachments in an appropriate orientation.

### Operation

The operation of the described embodiment of the present invention is believed to readily apparent and is briefly summarized at this point.

The present invention in its broadest aspect relates to a lawn grooming device 10 for use on a walk-behind lawn mower 100 having a rearwardly extending operator's control handle 103 as seen in FIG. 1. The lawn grooming device 10 includes an adjustable tow bar 12 mounted on an operator's handle 103 of the walk-behind lawn mower 100. Still further, a hitch member 30 is provided and mounted on the adjustable tow bar 12. In addition to the foregoing, the invention 10 includes a weighted earth engaging roller assembly 50 releasably coupled to the hitch member 30 and oriented in trailing relation relative to the walk-behind lawn mower 100. The weighted roller assembly is pivotally movable in both the horizontal and vertical plane relative to the tow bar 12 in order to achieve the benefits of the present invention. As earlier discussed, the weighted roller assembly 50 has a length and width dimension which does not substantially interfere with an operator's walking stride 100 as the operator 102 operates the walk-behind lawn mower 100. This is also clearly seen in FIG. 1.

Another aspect of the present invention relates to a lawn grooming device 10 for use on a walk-behind lawn mower 100 which includes a releasably adjustable tow bar 12 depending downwardly relative to an operator's handle 103 and which is mounted on the rear end 104 of the walk behind lawn mower 100. The releasably adjustable tow bar 12 is adjustable as to length (L) and width (W), and in angular orientation (A) relative to the operator's handle 103. The lawn grooming device of the present invention also includes a hitch member 30 mounted on the adjustable tow bar 12, and a frame 51 having a leading and trailing edge 47 and 49, respectively. The leading edge 47 is releasably engaged by the hitch member 30, and the frame 51 further defines a transversely, disposed cavity 54 which is located between the leading and trailing edges 47 and 49. The frame 51 is moveable in both horizontal and vertical planes relative to the walk-behind mower 100. In the form of the invention as described, an earth engaging roller 56 is rotatably mounted in the cavity 54 which is defined by the frame 51. The roller 56 further has an internal cavity 59. Still further, a flowable substance 53 is received within the internal cavity 59 of the earth engaging roller 56. The flowable substance increases the mass or weight of the earth engaging roller 56 to a degree which allows it to effectively bend blades of grass to produce an aesthetically appealing appearance on a grass surface (G) over which the earth engaging roller 56 travels.

Still another aspect of the present invention relates to a lawn grooming device 10 for use on a walk behind lawn mower 100 having a rearwardly extending operator's handle 103 which includes a first portion 76a of an attachment assembly 70a, and which has a main body defined by an outside facing surface 41a, and an inside facing surface 42a. The inside facing surface 42a defines a channel 91a which is dimensioned to conformably receive and mate with a portion of the operator's handle 103. The lawn grooming device 10 further has a second portion 74a of an attachment assembly 70a, and which has a main body defined by an outside facing surface 44a, and an inside facing surface 43a, and wherein the inside facing surface 43a defines a channel 92a which is dimensioned to conformably receive and mate with a portion of the operator's handle 103, and matingly fit together with the first portion 76a. The first and second portions 76a and 74a, respectively, are fastened together so as to securely capture the operator's handle 103 therebetween. The outside facing surface 44a further defines a plurality of spaced orientation teeth 93a, and a region 95a for receiving a distal end 17 of a depending substantially vertically oriented support member 13. The lawn grooming device 10 of the present invention further includes a third portion 72a of an attachment assembly 70a having a main body defined by an outside facing surface 46a, and an inside facing surface 45a. The inside facing surface 45a defines a channel 96a which is dimensioned to conformably receive and mate with a portion of the distal end 17 of the depending substantially vertically oriented support member 13, and secure the distal end 17 therebetween the second and third portions 74a and 72a, respectively. The third portion 72a includes a plurality of spaced orientation teeth 94a which matingly cooperate with the plurality of spaced orientation teeth 93a which are made integral with the second portion 74a so as to permit the third portion 72a to orient the depending substantially vertically oriented support member 13 in a plurality of predetermined angular orientations. The lawn grooming device 10 further includes a substantially horizontally oriented connector member 18 which is mounted on the substantially vertically oriented support members 13. A hitch member 30 is mounted on the substantially horizontally oriented connector member 18. Still further, a frame 51 is provided and has a leading and a trailing edge 47 and 49. The leading edge 47 is releasably engaged by the hitch member 30, and wherein the frame 51 further defines a transversely disposed cavity 54 located between the leading and trailing edges 47 and 49, respectively. The frame 51 is moveable in both horizontal and vertical planes relative to the walk behind lawn mower 100. In addition to the foregoing, the present invention includes an earth engaging roller 56 rotatably mounted in the cavity 54 which is defined by the frame 51. The roller 56 further has an internal cavity 59, and a flowable substance 53 is received within the internal cavity of the earth engaging roller 56, and which increases the mass or weight of the earth engaging roller 56 to a degree which allows it to effectively bend blades of grass to produce an aesthetically appealing appearance on a grass surface over which the earth engaging roller travels.

Therefore, it will be seen that the present lawn grooming device 10 of the present invention avoids many of the shortcomings attendant with the prior art devices which have been used heretofore to create aesthetically appealing appearances on grass covered surfaces.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A lawn grooming device for use on a walk behind lawn mower having a rearwardly extending operator's control handle, comprising:
an adjustable tow bar mounted on an operator's handle of a walk behind lawn mower, the tow bar being adjustable as to width and length;
a hitch member mounted on the adjustable tow bar; and
an earth engaging roller assembly releasably coupled to the hitch member, and oriented in trailing relation relative to the walk behind lawn mower, and wherein the roller assembly is pivotally moveable in both a horizontal and vertical plane relative to the tow bar.

2. A lawn grooming device as claimed in claim 1, and wherein the roller assembly is weighted, and has a length and width dimension which does not substantially interfere with an operator's walking stride as the operator operates the walk behind lawn mower.

3. A lawn grooming device as claimed in claim 1, and wherein the tow bar extends downwardly relative to the operator's handle and is disposed in spaced relation relative to a surface of the earth, and wherein the walk behind lawn mower further has a grass catching bag which is releasably mounted on the walk behind lawn mower, and which extends rearwardly thereof, and wherein the grass catching bag is positioned between the operators handle and the surface of the earth, and wherein the tow bar does not interfere with the operation of the grass catching bag.

4. (canceled)

5. A lawn grooming device as claimed in claim 1, and wherein the tow bar is angularly adjustable relative to the operator's handle of the walk behind lawn mower.

6. A lawn grooming device as claimed in claim 2, and wherein the weighted earth engaging roller assembly further comprises:
a frame having a cavity;
an earth engaging roller having an outwardly facing surface, and having an inwardly facing surface defining an internal cavity, and wherein the earth engaging roller further defines an aperture which allows access to the to the internal cavity, and wherein the earth engaging roller is rotatably mounted in the cavity of the frame; and
a flowable substance delivered to the internal cavity of the earth engaging roller through the aperture, and which increases the weight of the earth engaging roller to a degree which will permit the earth engaging roller to effectively bend blades of grass over when the earth engaging roller is moved across the surface of the earth.

7. A lawn grooming device as claimed in claim 6, and wherein a fender is made integral with the frame and is disposed in spaced, partially covering relation relative to the earth engaging roller.

8. A lawn grooming device as claimed in claim 6, and wherein the flowable substance may comprise a liquid, a granular solid, and/or combinations thereof.

9. A lawn grooming device as claimed in claim 6, and wherein the frame of the weighted earth engaging roller assembly has a forward, leading edge, and a rearward trailing edge, and wherein the hitch member engages the forward, leading edge, and wherein the adjustable tow bar engages the forward leading edge of the frame when the lawn grooming device is pushed backwards so as to impede the over-rotation of the frame about the hitch member.

10. A lawn grooming device for use on a walk behind lawn mower, comprising:
a releasably adjustable tow bar depending downwardly relative to an operator's handle which is mounted on a rear end of the walk behind lawn mower, and wherein the releasably adjustable tow bar is adjustable as to length, width and angular orientation relative to the operator's handle; the releasably adjustable tow bar comprising:
first and second generally vertically oriented support members mounted on the operator's handle and depending downwardly therefrom, and wherein the first and second vertically oriented support members are individually adjustable as to length; and
a substantially horizontally oriented connector member mounted on, and extending between the respective first and second generally vertically oriented support members, and wherein the horizontally oriented connector member is adjustable as to length, and wherein the hitch member is mounted about midway along the length of the substantially horizontally oriented connector member
a hitch member mounted on the adjustable tow bar;
a frame having a leading and a trailing edge, and wherein the leading edge is releasably engaged by the hitch member, and wherein the frame further defines a transversely disposed cavity located between the leading and trailing edges, and wherein the frame is moveable in both horizontal and vertical planes relative to the walk behind lawn mower;
an earth engaging roller rotatably mounted in the cavity which is defined by the frame, and wherein the roller further has an internal cavity; and
a flowable substance received within the internal cavity of the earth engaging roller and which increases the weight of the earth engaging roller to a degree which allows it to effectively bend blades of grass to produce an aesthetically appealing appearance on a grass surface over which the earth engaging roller travels.

11. (canceled)

12. A lawn grooming device as claimed in claim 10, and wherein the first and second generally vertically oriented support members, and the substantially horizontally oriented support member are adjustable as to length in predetermined increments.

13. A lawn grooming device as claimed in claim 12, and further comprising:
an attachment assembly mounted on the operator's handle of the walk behind lawn mower and which engages, and adjustably positions, each of the substantially vertically oriented support members in a predetermined angularly depending relationship relative to the operator's handle.

14. A lawn grooming device as claimed in claim 13, and wherein the attachment assembly positions the adjustable tow bar in predetermined angular increments relative to the operator's handle.

15. A lawn grooming device as claimed in claim 14, and wherein the attachment assembly further comprises:
a first portion having an inside and an outside facing surface, and wherein the inside facing surface conformably mates, at least in part, to the operator's handle;
a second portion, matingly coupling with the first portion, and which has an inside facing surface which conformably mates, at least in part, to the operators handle, and wherein the operator's handle is positioned therebetween the first and second portions, and wherein the outside facing surface defines, at least in part, a cavity for receiving the distal end of one of the substantially vertically oriented support members; and
a third portion having an inside facing surface which matingly couples with the outside facing surface of the of the second portion, and wherein the inside facing surface further conformably mates, at least in part, to the distal end of one of the substantially vertically oriented support members, and wherein the distal end of the substantially vertically oriented support member is captured within a cavity defined by the outside facing surface of the second portion and the inside facing surface of the third portion.

16. A lawn grooming device as claimed in claim 15, and wherein the frame mounting the earth engaging roller has a width dimension which is less than about the width dimension of the walk behind mower, and a length dimension which allows the frame to be operably deployed in trailing relation relative to the walk behind mower and substantially outside the walking gait of an average operator who is operating the walk behind mower.

17. A lawn grooming device as claimed in claim 15, and wherein the releasably adjustable tow bar cooperates with the leading edge of the frame when the walk behind lawn mower is pulled backwards so as to inhibit the jackknifing of the frame relative to the walk behind lawn mower.

18. A lawn grooming device as claimed in claim 15, and wherein the frame has an integral fender which is positioned in spaced, partially covering relation relative to the earth engaging roller, and wherein the walk behind mower has a rear mounted grass catching bag which rests on the fender and out of contact with the earth engaging roller.

19. A lawn grooming device as claimed in claim 15, and wherein the frame has a length dimension of greater than about 12 inches to less than about 17 inches; and a width dimension of greater than about 16 inches to less than about 21 inches.

20. A lawn grooming device as claimed in claim 15, and wherein the predetermined adjustable length increments of the respective substantially vertically oriented support members are about 0.75 inches, and the substantially horizontally oriented connector member is about 0.50 inches.

21. A lawn grooming device as claimed in claim 15, and wherein the substantially vertically oriented support members have a total range of adjustment of less than about 140 degrees, and are further adjustable in individual angular increments of about 10 degrees.

22. A lawn grooming device as claimed in claim 15, and wherein the earth engaging roller, when substantially filled with the flowable substance weighs about 17 pounds to about 34 pounds.

23. A lawn grooming device for use on a walk behind lawn mower having a rearwardly extending operator's handle, comprising:
a first portion of an attachment assembly having a main body defined by an outside facing surface, and an inside facing surface, and wherein the inside facing surface defines a channel which is dimensioned to conformably receive and mate with a portion of the operator's handle;
a second portion of an attachment assembly which has a main body defined by an outside facing surface, and an inside facing surface, and wherein the inside facing surface defines a channel which is dimensioned to conformably receive and mate with a portion of the operator's handle and matingly fit together with the first portion, and wherein the first and second portions are fastened together so as to securely capture the operator's handle therebetween, and wherein the outside facing surface further defines a plurality of spaced orientation teeth, and a region for receiving a distal end of a depending substantially vertically oriented support member;
a third portion of an attachment assembly having a main body defined by an outside facing surface, and an inside facing surface, and wherein the inside facing surface defines a channel which is dimensioned to conformably receive and mate with a portion of the distal end of the depending substantially vertically oriented support member and secure the distal end therebetween the second and third portions, and wherein the third portion includes a plurality of spaced orientation teeth which matingly cooperate with the plurality of spaced orientation teeth made integral with the second portion so as to permit the third portion to orient the depending substantially vertically oriented support member in a plurality of predetermined angular orientations;
a substantially horizontally oriented connector member mounted on the substantially vertically oriented support member;
a hitch member mounted on the substantially horizontally oriented connector member;
a frame having a leading and a trailing edge, and wherein the leading edge is releasably engaged by the hitch member, and wherein the frame further defines a transversely disposed cavity located between the leading and trailing edges, and wherein the frame is moveable in both horizontal and vertical planes relative to the walk behind lawn mower;
an earth engaging roller rotatably mounted in the cavity which is defined by the frame, and wherein the roller further has an internal cavity; and
a flowable substance received within the internal cavity of the earth engaging roller and which increases the weight of the earth engaging roller to a degree which allows it to effectively bend blades of grass to produce an aesthetically appealing appearance on a grass surface over which the earth engaging roller travels.

24. A lawn grooming device as claimed in claim 23, and wherein the substantially vertically oriented support member comprises two substantially vertically oriented support members, and wherein a portion of each of the substantially vertically oriented support members releasably engages the substantially horizontally oriented connector member.

25. The lawn grooming device as claimed in claim 24, and wherein each of the substantially vertically oriented support members mounts a detent, and wherein the substantially horizontally oriented connector member defines a plurality of receiving holes for matingly receiving the detent, and wherein the length of the substantially vertically oriented support member can be adjusted by locating the detent in selected receiving holes.

26. A lawn grooming device as claimed in claim 23, and wherein the substantially vertically oriented support member comprises two substantially vertically oriented side members, and wherein each of the two substantially vertically oriented side members have a distal end which is telescopingly received within the substantially horizontally oriented connector member.

27. A lawn grooming device comprising:
a tow bar;
a weighted roller;
a frame connecting the weighted roller to the tow bar; and
an angularly adjustable attachment device configured to attach the tow bar to an operator's handle of a walk-behind mower, the angularly adjustable tow bar having an inner portion, a center portion having spaced orientation teeth, and an outer portion having spaced orientation teeth, the spaced orientation teeth of the center portion being positioned to matingly cooperate with the spaced orientation teeth of the outer portion such that the angularly adjustable attachment device is adjustable so as to change the angle of the tow bar relative to the operator's handle; and
wherein the tow bar extends downwardly relative to the operator's handle and is disposed in spaced relation relative to a surface of the earth, the walk-behind mower having a grass catching bag which is releasably mounted on the walk-behind mower and which extends rearwardly thereof, positioned between the operator's handle and the surface of the earth such that the tow bar does not interfere with the operation of the grass catching bag.

28. A lawn grooming device as claimed in claim 30, and wherein the vertical and horizontal dimensions of the tow bar are adjustable.

29. A lawn grooming device as claimed in claim 27, and wherein the roller is partially covered by a fender.

30. A lawn grooming device as claimed in claim 27, and wherein the tow bar is attached to the frame by a tow hook.

31. A lawn grooming device as claimed in claim 27, and wherein the roller is filled with a fluid.

32. A lawn grooming device as claimed in claim 27, and wherein the roller is filled with a non-fluid substance.

33. A lawn grooming device as claimed in claim 27, and wherein the angularly adjustable attachment device is configured to adjust the angle of the tow bar relative to the operator's handle in about 10 degree increments.
